(19) United States
(12) Patent Application Publication
(10) Pub. No.: US 2026/0030866 A1
(43) Pub. Date: Jan. 29, 2026

(54) METHODS FOR IMAGE CLASSIFICATION AND SYSTEMS FOR IMAGE CLASSIFICATION

(71) Applicant: INNOPEAK TECHNOLOGY, INC., Palo Alto, CA (US)

(72) Inventors: Yikang LI, Palo Alto, CA (US); Shichao XU, Palo Alto, CA (US); Jenhao HSIAO, Palo Alto, CA (US); Chiu Man HO, Palo Alto, CA (US)

(73) Assignee: INNOPEAK TECHNOLOGY, INC., Palo Alto, CA (US)

(21) Appl. No.: 18/994,033

(22) PCT Filed: Dec. 23, 2022
(86) PCT No.: PCT/US2022/082371

§ 371 Date: Jan. 13, 2025

Related U.S. Application Data
(60) Provisional application No. 63/397,065, filed on Aug. 11, 2022.
(60) Provisional application No. 63/397,069, filed on Aug. 11, 2022.

(51) Int. Cl. G06V 10/764; G06V 10/82

(52) U.S. Cl. CPC G06V 10/764; G06V 10/82

(57) ABSTRACT

The present invention is directed to image classification techniques. In a specific embodiment, the present invention provides an image classification system that receives a first query generated from a textual embedding and a first key and value generated from a visual embedding to facilitate the fusion of the semantics from a dual-modality information source. A second query generated from the visual embedding is employed to further refine the semantic understanding. There are other embodiments as well.

### CROSS-REFERENCES TO RELATED APPLICATIONS

The present application claims priority to U.S. Provisional Application No. 63/397,065, entitled “Dual-Modality Fusion Decoder for (zero-shot) Multi-Label Classification with Vision-Language Pre-training Model,” filed on Aug. 11, 2022, and U.S. Provisional Application No. 63/397,069, entitled “Pyramid-Forwarding Strategy for Zero-shot Multi-Label Classification with Vision-Language Pre-training Model,” filed on Aug. 11, 2022, which are commonly owned and incorporated by reference herein for all purposes.

### BACKGROUND OF THE INVENTION

As more and more multimedia data are stored online, recognizing and retrieving images from a large amount of digital media content has become ubiquitous. Various cloud services offered various types of automatic image labeling. For example, image classification has been widely used to categorize digital images based on the content or objects contained therein, thereby allowing accurate and efficient retrial.

There have been various conventional techniques for image classification, but they have been inadequate, for the reasons provided below. Therefore, new and improved methods and systems are desired.

### BRIEF SUMMARY OF THE INVENTION

The present invention is directed to image classification techniques. In a specific embodiment, the present invention provides an image classification system that receives a first query generated from a textual embedding and a first key and value generated from a visual embedding to facilitate the fusion of the semantics from a dual-modality information source. A second query generated from the visual embedding is employed to further refine the semantic understanding. There are other embodiments as well.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for image classification. The method also includes obtaining a first image and a plurality of text data. The method also includes extracting a visual embedding using the first image. The method also includes extracting a textual embedding using the plurality of text data. The method also includes generating a first query using at least the textual embedding. The method also includes generating a first key and a first value using at least the visual embedding. The method also includes calculating a first correlation between the first query and the first key. The method also includes generating a second key and a second value based at least on the first correlation. The method also includes generating a second query using at least the visual embedding. The method also includes calculating a second correlation between the second query and the second key. The method also includes generating a third key and a third value based at least on the second correlation. Other embodiments of this aspect include corresponding computer systems, apparatus, and computer programs recorded on one or more computer storage devices, each configured to perform the actions of the methods.

Implementations may include one or more of the following features. The method may include generating a third query using at least the first query. The method may include outputting the third query. The method may include outputting the third key and the third value. The plurality of text data may include label class information. The visual embedding is aligned with the textual embedding via a pre-trained model. The pre-trained model may be stored in a data storage. The method may include generating a probability value associated with a relevance between the first image and the plurality of text data. The first image is stored in a memory. Implementations of the described techniques may include hardware, a method or process, or computer software on a computer-accessible medium.

One general aspect includes a system for image classification. The system also includes a communication interface configured to obtain a first image and a plurality of text data. The system also includes a memory coupled to the communication interface, the memory being configured to store the first image and the plurality of text data. The system also includes a processor coupled to the data storage. The processor is configured for: extracting a visual embedding using the first image, extracting a textual embedding using the plurality of text data, generating a first query using at least the textual embedding, generating a first key and a first value using at least the visual embedding, calculating a first correlation between the first query and the first key, generating a second key and a second value based at least on the first correlation, generating a second query using at least the visual embedding, calculating a second correlation between the second query and the second key, and generating a third key and a third value based at least on the second correlation. Other embodiments of this aspect include corresponding computer systems, apparatus, and computer programs recorded on one or more computer storage devices, each configured to perform the actions of the methods.

Implementations may include one or more of the following features. The processor may include a graphics processing unit (GPU) and/or a central processing unit (CPU), and/or a neural network processing unit (NPU). The processor is further configured to generate a third query using at least the first query. The system may include a data storage configured to store a pre-trained model, which is configured to align the textual embedding with the visual embedding. The processor is further configured to generate a probability value associated with a relevance between the first image and the plurality of text data. Implementations of the described techniques may include hardware, a method or process, or computer software on a computer-accessible medium.

One general aspect includes a method for image classification. The method includes obtaining a first image. The first image may include one or more objects. The method also includes obtaining a plurality of text data. The plurality of text data may include one or more label classes corresponding to the one or more objects. The method also includes extracting a visual embedding using the first image. The method also includes extracting a textual embedding using the plurality of text data. The method also includes generating a first query using at least the textual embedding. The method also includes generating a first key and a first value using at least the visual embedding. The method also includes calculating a first correlation between the first query and the first key. The method also includes generating a second key and a second value based at least on the first correlation. The method also includes generating a second query using at least the visual embedding. The method also includes calculating a second correlation between the second query and the second key. The method also includes generating a third key and a third value based at least on the second correlation. Other embodiments of this aspect include corresponding computer systems, apparatus, and computer programs recorded on one or more computer storage devices, each configured to perform the actions of the methods.

Implementations may include one or more of the following features. The method may include generating one or more probability values indicating relevance between the one or more objects and the one or more label classes. The method may include determining one or more image labels associated with the one or more objects based at least on the one or more probability values. The method may include generating a third query using at least the first query. The method may include generating a fourth query and a fourth key and a fourth value using at least the third query and the third key and the third value. The method may include calculating a third correlation between the third query and the third key. Implementations of the described techniques may include hardware, a method or process, or computer software on a computer-accessible medium.

The embodiments of the present invention, using machine learning techniques, efficiently and accurately classify an image into one or more classes. The embodiments of the present invention provide many advantages over conventional techniques. Among other things, dual-modal decoder are implemented to explore alignment of textual and visual embeddings to provide multi-label classification results with high accuracy. Additionally, the image classification system of the present invention provides a robust solution in zero-shot scenarios where the unseen classes in unseen images can be identified to improve classification accuracy. There are other benefits as well.

The present invention achieves these benefits and others in the context of known technology. However, a further understanding of the nature and advantages of the present invention may be realized by reference to the latter portions of the specification and attached drawings.

### BRIEF DESCRIPTION OF THE DRAWINGS

FIG. 1 is a simplified block diagram illustrating system 100 for image classification according to the embodiments of the present invention.

FIG. 2 is a simplified block diagram illustrating data flow 200 for image classification according to the embodiments of the present invention.

FIG. 3 is a simplified block diagram illustrating image classification system 300 according to the embodiments of the present invention.

FIG. 4 is a simplified flow diagram illustrating method 400 for image classification according to embodiments of the present invention.

### DETAILED DESCRIPTION OF THE INVENTION

The present invention is directed to image classification systems and methods thereof. In a specific embodiment, the present invention provides an image classification system that receives a first query generated from a textual embedding and a first key and value generated from a visual embedding to facilitate the fusion of the semantics from a dual-modality information source. A second query generated from the visual embedding is employed to further refine the semantic understanding. There are other embodiments as well.

Over the years, many techniques for image classification have been developed, including both traditional and deep learning approaches. Deep learning approaches-such as neural networks trained with pre-labeled datasets-provide a scalable solution to tackle the increasing number of label classes as the volume of data grows exponentially. Many existing approaches rely on single-label classification, which assumes that each image contains only one item, scene, or concept of interest to label and can be limiting in realistic scenarios involving multiple objects. Multi-label classification, on the other hand, aims to generate labels for the multiple objects contained in the image, providing a more comprehensive understanding of the image scene. However, it remains a challenging task to recognize objects in the image accurately and efficiently, especially when the object of interest has never been seen during the previous training process.

Embodiments of the present invention provide a complete image classification system for assigning multiple labels to the input image based on the image elements contained therein, which allows for efficient retrieval of images in response to a given query keyword. The system leverages the dual modality to enhance transformer decoder layers by progressively fusing visual embeddings with textual information and developing a richer semantic understanding. Additionally, the present invention implements various deep learning strategies to enhance the generality and usability; the resulting system can identify the previously seen object categories (referred to as “conventional multi-label classification”) and even recognize the previously unseen object categories (referred to as “zero-shot multi-label classification”). Overall, embodiments of the present invention achieve competitive classification results in various scenarios including multi-label classification, zero-shot multi-label classification, and/or the like.

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

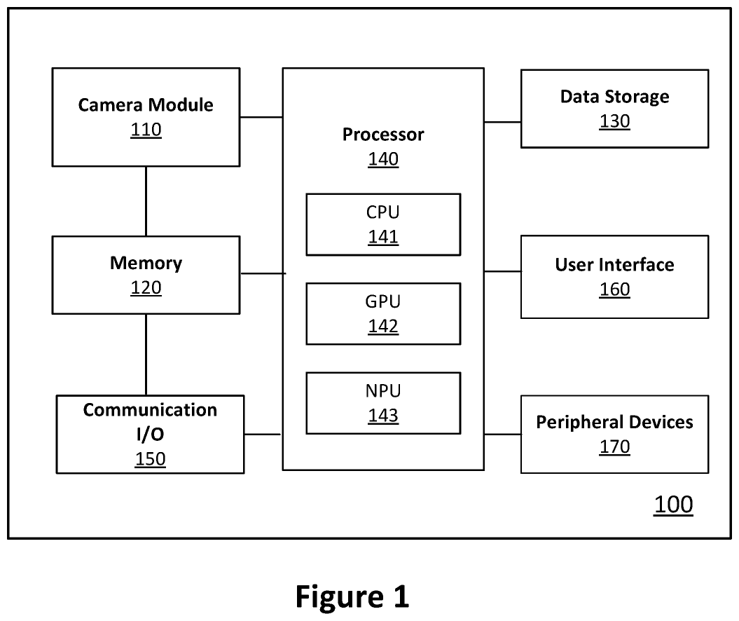

FIG. 1 is a simplified block diagram illustrating system 100 for image classification according to embodiments of the present invention. This diagram is merely an example, which should not unduly limit the scope of the claims. One of ordinary skill in the art would recognize many variations, alternatives, and modifications.

As shown, system 100 includes camera module 110, memory 120, data storage 130, processor 140, and communication interface 150. Memory 120 is coupled to communication interface 150, which is configured to obtain a first image and a plurality of text data. In another example, the first image may be captured by camera module 110 and stored in memory 120. Memory 120 may include a random-access memory (RAM) device, an image buffer device, or the like. In some cases, the first image includes one or more objects. The plurality of text data includes label class information. For example, one or more label classes of the plurality of text data correspond to one or more objects contained in the first image.

In various implementations, data storage 130 is configured to store a pre-trained model, which is used to align visual and textual features. Data storage 130 may include, without limitation, local and/or network-accessible storage, a disk drive, a drive array, an optical storage device, and a solid-state storage device, which can be programmable, flash-updateable, and/or the like. Processor 140 can be coupled to each of the previously mentioned components and be configured to communicate between these components. In a specific example, processor 140 includes central processing unit (CPU) 141, graphics processing unit (GPU) 142, and/or network processing unit (NPU) 143, or the like. For example, each of the processing units may include one or more processing core for parallel processing. In a specific embodiment, CPU 141 includes both high-performance cores and energy-efficient cores.

In some embodiments, system 100 further includes user interface 160. For example, user interface 160 is configured to display the first image in response to user input. In some cases, user interface 160 is a touchscreen display (e.g., in a mobile device, tablet, etc.), which can receive the user's query (e.g., a label class) as input for image search and display the search results (e.g., one or more images containing objects of the class). In various implementations, system 100 further includes one or more peripheral devices 170 configured to improve user interaction in various aspects. For example, peripheral devices 170 may include, without limitation, at least one of the speaker(s) or earpiece(s), audio sensor(s) or microphone(s), noise sensors, keyboard, mouse, and/or other input/output devices.

In a specific example, processor 140 includes central processing unit (CPU) 141, graphics processing unit (GPU) 142, and/or neural network processing unit (NPU) 143, or the like. CPU 141 may be configured to handle various types of system functions, such as retrieving the first image and the plurality of text data from memory 120, and executing executable instructions (e.g., feature extraction, feature alignment, feature mapping, etc.). In some embodiments, GPU 142 may be specially designed to facilitate image processing. For example, GPU 142 is configured to convert the image input (e.g., the first image) into a plurality of spatial regions. In some cases, the GPU may further perform a downsampling function during the visual embedding extraction. NPU 143 can be configured to perform model training processes and other machine/deep learning-related processes. In various implementations, NPU 143 embedded in the processor 140 adopts a data-driven parallel computing architecture and is particularly good at processing massive image and text data. For example, NPU 143 includes modules that implement an encoder-decoder architecture for performing multi-head cross-attention, feedforward, add and normalization, softmax, dot product, and/or other functions in a neural network.

Other embodiments of this system include corresponding computer systems, apparatus, and computer programs recorded on one or more computer storage devices, each configured to perform the actions of the methods. Elements of system 100 can be configured together to perform an image classification process to determine correlations between one or more label classes and one or more objects included in the image input, as further described below.

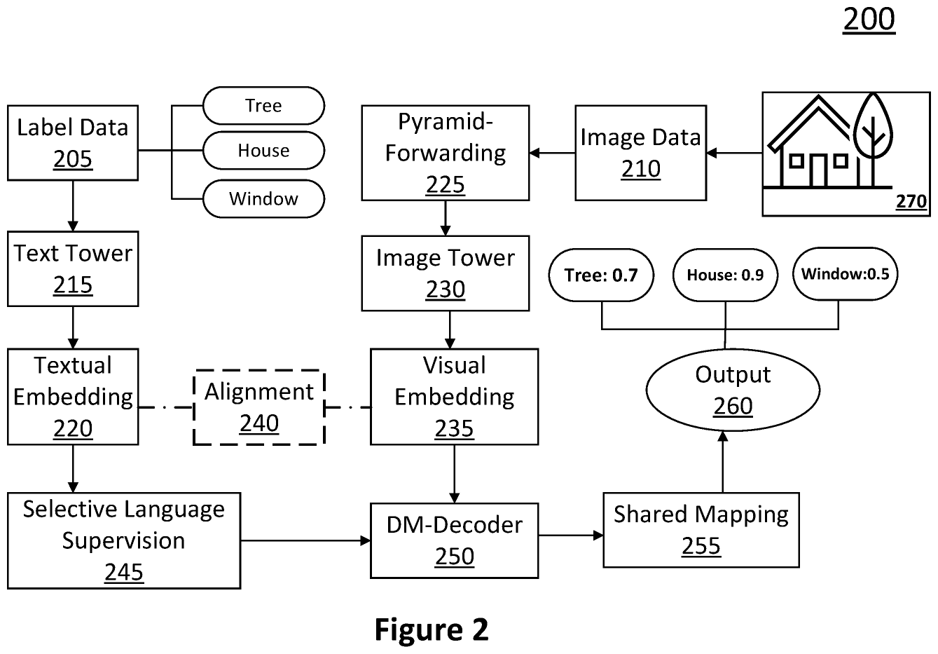

FIG. 2 is a simplified block diagram illustrating data flow 200 for image classification according to embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

According to an example, the present invention provides a method to identify and/or predict one or more label classes of the image input by analyzing the correlations between the image and text inputs. As shown, data flow 200 starts with receiving label data 205 and image data 210. For example, label data 205 include a plurality of label classes in natural language words for potentially describing the objects (e.g., tree, apple, computer, etc.), scenes (e.g., sea, sky, undergrounds, etc.), or concepts (e.g., small, red, high, etc.) of interests contained in an image. As the example shown in FIG. 2, label data 210 includes label classes such as tree, house, window, etc. Depending on the implementation, label data 205 may first be combined with a textual prompt (e.g., “This photo contains . . . ”) before being fed into text tower 215 for feature extraction. Text tower 215 is configured to generate textual embedding 220 using at least the label data 205.

In various implementations, image data 210 is processed in parallel with label data 205. For example, image data 210 may be first sent to pyramid-forwarding module for preprocessing to enhance the performance for inputs with high resolutions (e.g., 448×448 or higher). The first image may include one or more objects/scenes/concepts. As the example shown in FIG. 2, image data 210 includes first image 270 depicting a scene of one's residence, which includes objects such as trees, a house, and a window. Image tower 230 then receives the image input (i.e., first image 270) for visual feature extraction and generates visual embedding 235.

In various implementations, to boost the system performance under various conditions (e.g., zero-shot multi-label classification or the like), textual embedding 220 and visual embedding 235 may be aligned at alignment module 240 via a pre-trained model based on the correlation between text and image. For instance, the pre-trained model is trained on a variety of image-text pairs and can predict the most relevant text description in response to an image input. The pre-trained model may be stored in a data storage (e.g., data storage 130 of FIG. 1). In an example of zero-shot multi-label classification, the training data contains the images {x _{(img, seen)}} and the labels X_{(lbl, seen)}. The objective is to learn a classifier g to make predictions on an unseen image x _{(img, unseen)} with unseen categories X _{(lbl, unseen)}. To improve the system's generalizability to unseen categories, the relationship between the visual and textual embeddings is further explored in alignment module 240. At alignment module 240, an additional soft constraint may be applied on the visual embedding 235 and textual embedding 220 as:

$$\{ \begin{matrix}g ( {f}_{img} ( {x}_{( img , unseen )} ) , {f}_{lbl} ( {x}_{( lbl , unseen )} ) ) ∈ \{ 0 , 1 \} . \\ cos ( \frac{{f}_{img} ( {x}_{( img , unseen )} )}{\vert {f}_{img} ( {x}_{( img , unseen )} ) \vert} , \frac{{f}_{lbl} ( {x}_{( lbl , unseen )} )}{\vert {f}_{lbl} ( {x}_{( lbl , unseen )} ) \vert} ) \to 1 - ϵ , \\ if g ( {f}_{img} ( {x}_{( img , unseen )} ) , {f}_{lbl} ( {x}_{( lbl , unseen )} ) ) = 1 , else ϵ ,\end{matrix} \qquad ( Eqn . 1 )$$

where f_{img} denotes the image encoder, f_{lbl} denotes the text encoder, and E is a small value determined by the pre-trained model to convert the multi-label classification into a regression task: given the inputs {(a, b)}, and the corresponding label

$$\{ l \} ( l = 1 if cos \frac{a}{\vert a \vert} , \frac{b}{\vert b \vert} ) = 1 - ϵ ,$$

else 0), learn a model g that satisfies:

$$g ( \frac{a}{\vert a \vert} , \frac{b}{\vert b \vert} ) = 1 \qquad ( Eqn . 2 )$$

Depending on the implementations, selective language supervision 245 may be applied to selectively utilize the input label classes during the training process to reduce computational cost and memory usage while ensuring the training performance. For example, given multi-label L={l₁, l₂, . . . , lₖ} from a training batch B with k classes in total, a number of positive labels Sₚₒₛ={i/lᵢ=1,lᵢ∈L, L∈B} and a number of negative labels S_{neg}{1, 2, . . . , k}−Sₚₒₛ are selected, and the selected label set for batch B training is:

$${S}^{′} = {S}_{pos} ⋃ {S}_{slt} \qquad ( Eqn . 3 )$$

where elements in Sₛₗₜ are randomly selected from S_{neg}|Sₛₗₜ|=min(α*|Sₚₒₛ|, k−|Sₚₒₛ|), a is a hyper-parameter balancing the number of positive and negative samples (e.g., α=3). It is to be appreciated that selective language supervision 245—in consideration of balanced sample data distribution—effectively reduces the number of labels involved in the training process, enabling the system to scale well to a large number of label classes (e.g., greater than 1k).

In various embodiments, the aligned textual embedding 220 (e.g., after the selective language supervision 245) and visual embedding 235 are fed into dual-modal decoder (“DM-decoder”) 250 to determine the probability value of each label class in label data 205 with respect to the objects/scenes/concepts contained in image data 210 (e.g., first image 270). The probability value indicates the relevance between one or more objects/scenes/concepts and each label class. The higher the probability value, the more likely the corresponding label class can be used to tag the image for classification. Depending on the implementations, DM-decoder 250 can comprise a single-layer architecture or a multi-layer architecture (e.g., six-layer). DM-decoder 250 facilitates the fusion of the semantics from a dual-modal information source (i.e., image and text) with an initial query from textual embedding 220 and an initial key-value pair from visual embedding 235, as described in further detail below.

The output of DM-decoder 250 is later forwarded to shared mapping module 255 to perform a shared mapping among all labels and generate the probability value for each label class as output 260. As the example shown in FIG. 2, output 260 of system 200 includes the probability value for each of the input label classes (Tree: 0.7; House: 0.9; Window: 0.5).

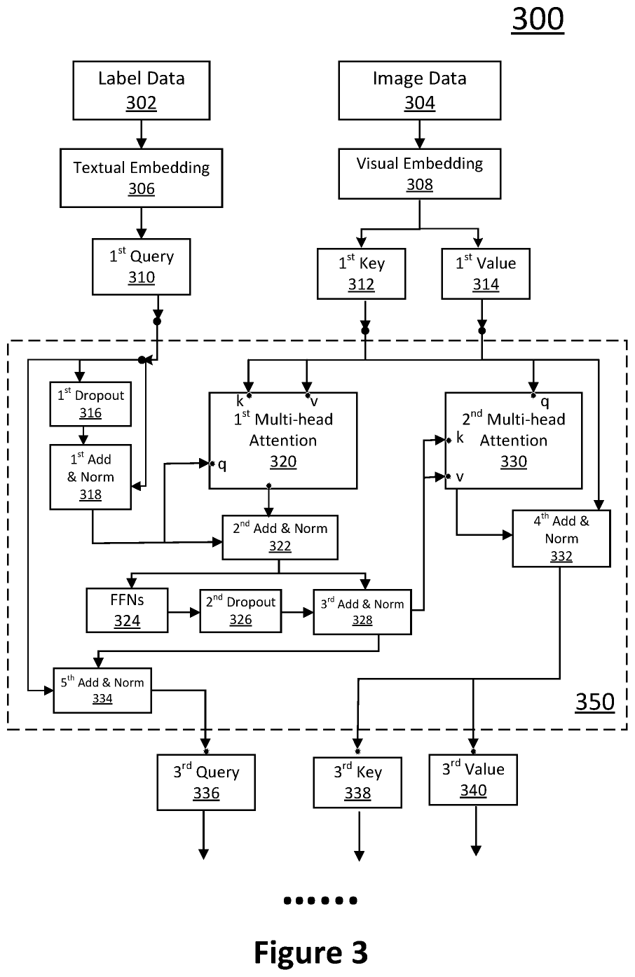

FIG. 3 is a simplified block diagram illustrating image classification system 300 according to embodiments of the present invention. This diagram is merely an example, which should not unduly limit the scope of the claims. One of ordinary skill in the art would recognize many variations, alternatives, and modifications.

As shown, system 300 receives label data 302 and image data 304 as inputs. For example, label data 302 includes a plurality of label classes in natural language words for describing the objects (e.g., tree, apple, computer, etc.), scenes (e.g., sea, sky, undergrounds, etc.), or concepts (e.g., small, red, high, etc.) of interests contained in an image. Image data 304 may include a first image, which contains one or more objects/scenes/concepts. In various implementations, textual embedding 306 is extracted from label data 302 (e.g., implemented with CPU 141of FIG. 1), and visual embedding 308 is extracted from image data 304 (e.g., implemented with GPU 142/NPU 143 of FIG. 1).

In various embodiments, system 300 adopts an attention mechanism to determine the per-class probability by querying the textual embedding 306 from the visual embedding 308. For example, first query 310 is generated from textual embedding 306. First key 312 and first value 314 are generated from visual embedding 308. First query 310, first key 312, and first value 314 are then forwarded to DM-decoder 350 as initial inputs.

Depending on the implementations, DM-decoder 350 comprises one or more decoding layers that process the input iteratively one layer after another to generate the output. In an example, first dropout layer 316 receives first query 310. A random set of nodes in the first dropout layer 316 is omitted for further processing to prevent over-fitting on the training data. First Add&Norm layer 318 receives the output of first dropout layer 316. In some cases, first Add&Norm layer 318 comprises an add layer and a normalization layer (not shown). The add layer is configured to provide residual connection by adding its input to the output. The normalization layer is configured for performing layer normalization to stabilize the training process. The output of first Add&Norm layer 318 may later be forwarded to first multi-head cross-attention layer 320. The output of first Add&Norm layer 318 is denoted as:

$${Q}_{mid}^{1} = LayerNorm ( {Q}_{lbl} + DP ( {Q}_{lbl} ) ) \qquad ( Eqn . 4 )$$

In an example, first key 312 and first value 314 generated from visual embedding 308 also are forwarded to first multi-head cross-attention layer 320 as input. The first multi-head cross-attention layer 320 is configured to calculate a first correlation between first query 310 and the first key 312. The output of first multi-head cross-attention layer 320 is denoted as:

$${Q}_{mid}^{2} = {MultiHdAttn}_{1} ( {Q}_{mid}^{1} , {K}_{img} , {V}_{img} ) \qquad ( Eqn . 5 )$$

The output of first multi-head cross-attention layer 320 may then be transformed by addition and normalization at second Add&Norm layer 322. For example, second Add&Norm layer 322 comprises an add layer and a normalization layer. The add layer is configured to provide residual connection by adding its input to the output. The normalization layer is configured for performing layer normalization to stabilize the training process. The output of second Add&Norm layer 322 is denoted as:

$${Q}_{mid}^{3} = LayerNorm ( {Q}_{mid}^{2} + {Q}_{mid}^{1} ) \qquad ( Eqn . 6 )$$

According to some embodiments, the output of second Add&Norm layer 322 is later processed by one or more fully-connected layers 324 and second dropout layer 326. The output of second dropout layer 326 is denoted as:

$${Q}_{mid}^{4} = DP ( {FFN}_{1} ( ReLU ( {FFN}_{2} ( {Q}_{mid}^{3} ) ) ) ) \qquad ( Eqn . 7 )$$

The output of second dropout layer 326 may then be transformed by addition and normalization at third Add&Norm layer 328. For example, third Add&Norm layer 328 comprises an add layer and a normalization layer. The add layer is configured to provide residual connection by adding its input to the output. The normalization layer is configured for performing layer normalization to stabilize the training process. The output of he third Add&Norm layer 328 is denoted as:

$${Q}_{mid}^{5} = LayerNorm ( {Q}_{mid}^{4} + {Q}_{mid}^{3} ) \qquad ( Eqn . 8 )$$

It is to be appreciated that the output

$${Q}_{mid}^{5}$$

of third Add&Norm layer 328 contains the weighted sum of the image token's embedding guided by the textual information. To develop a richer semantic understanding, second multi-head cross-attention layer 330 may be employed to enhance the key and value inputs. For example, following third Add&Norm layer 328, a second key and a second value are generated based at least on the first correlation and are forwarded to second multi-head cross-attention layer 330 as inputs.

Depending on the implementations, in addition to textual embedding 306, visual embedding 308 is also used as the query. For instance, a second query is generated from visual embedding 308 to query the output

$${Q}_{mid}^{5} .$$

At second multi-head cross-attention layer 330, a second correlation between the second query and the second key is calculated. The output

$${Q}_{mid}^{5}$$

(i.e., the weighted sum of image tokens' embedding guided by the textual information) can be redistributed to each image token's embeddings through the second multi-head cross-attention layer 330 to further refine the visual embedding according to the second correlation. The output of second multi-head cross-attention layer 330 is denoted as:

$${V}_{img}^{1} = {MultiHdAttn}_{2} ( {V}_{img} , {Q}_{mid}^{5} , {Q}_{mid}^{5} ) \qquad ( Eqn . 9 )$$

The output of second multi-head cross-attention layer 330 may be transformed by fourth Add&Norm layer 332 to generate third key 338 and third value 340. For example, fourth Add&Norm layer 332 comprises an add layer and a normalization layer. The add layer is configured to provide residual connection by adding its input to the output. The normalization layer is configured for performing layer normalization to stabilize the training process. The output of fourth Add&Norm layer 332 are denoted as:

$${V}_{img}^{′} = LayerNorm ( {V}_{img}^{1} + {V}_{img} ) \qquad ( Eqn . 10 )$$

$${K}_{img}^{′} = {V}_{img}^{′} \qquad ( Eqn . 11 )$$

In various implementations, an additional skipping connection from the query input (i.e., the first query 310) to the query output may be added and transformed by fifth Add&Norm layer 334 to generate third query 336. For example, fifth Add&Norm layer 334 comprises an add layer and a normalization layer. The add layer is configured to provide residual connection by adding its input to the output. The normalization layer is configured for performing layer normalization to stabilize the training process. The output of fifth Add&Norm layer 334 is denoted as:

$${Q}_{lbl}^{′} = LayerNorm ( {Q}_{mid}^{5} + {Q}_{lbl} ) \qquad ( Eqn . 12 )$$

According to an example, third query 336, third key 338, and third value 340 may be the output of DM-decoder 350. As explained above, DM-decoder 350 may comprise a single decoder layer or multiple decoder layers (e.g., six layers) with each layer having a similar architecture as illustrated in FIG. 3. It is to be appreciated that the training performance can benefit from the increase of the network depth and stacking of the transformer decoder. Each decoder layer adopts a similar attention mechanism, which draws information from the outputs of the previous decoder layer. In an example, third query 336, third key 338, and third value 340 may be fed into the next decoding layer as input to generate a fourth query, a fourth key, and a fourth value via a similar process.

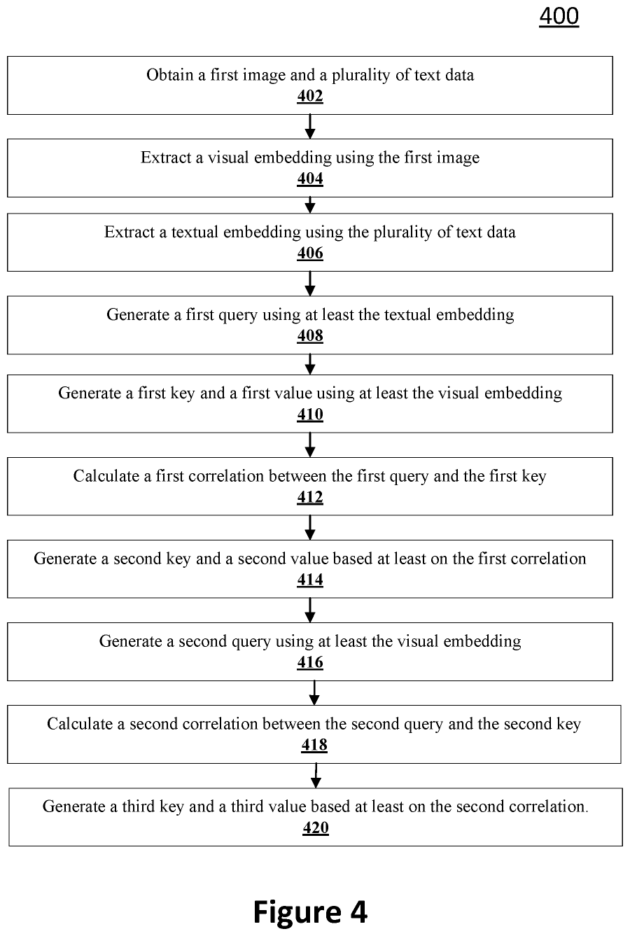

FIG. 4 is a simplified flow diagram illustrating method 400 for image classification according to embodiments of the present invention. This diagram is merely an example, which should not unduly limit the scope of the claims. One of ordinary skill in the art would recognize many variations, alternatives, and modifications. For example, one or more steps may be added, removed, repeated, replaced, modified, rearranged, and/or overlapped, and they should not limit the scope of the claims.

According to an example, the method for image classification can be performed by a computing system, such as system 100 of FIG. 1. As shown, method 400 includes step 402 of obtaining a first image and a plurality of text data. The first image and the plurality of text data may be obtained by network transfer or user upload and serve as the training data to train system 100 for categorizing the image input into one or more classes using deep learning strategies. In an example, the plurality of text data includes label class information such as a plurality of label classes in natural language words for describing objects, scenes, and/or concepts of interests contained in an image. The first image includes one or more objects/scenes/concepts and is characterized by a predetermined resolution (e.g., 448×448 or higher).

In steps 404 and 406, the method includes extracting a visual embedding using the first image and extracting a textual embedding using the plurality of text data. Referring to system 100 of FIG. 1, the input image and text data may be stored at memory 120 and retrieved by processor 140 for feature extraction. For example, CPU 141 is configured to extract textual embedding using the plurality of text data. GPU 142 is configured to extract visual embedding using the first image. In some cases, to boost the system performance under various conditions (e.g., zero-shot multi-label classification, and/or the like), the visual embedding is aligned with the textual embedding via a pre-trained model, which is based on the correlation between the text and image.

In steps 408 and 410, the method includes generating a first query using at least the textual embedding and generating a first key and a first value using at least the visual embedding. The first query, key, and value may be taken into a decoder to determine the per-class probability based on an attention mechanism. The decoder may be a dual-modal decoder, which leverages the dual modality to enhance transformer decoder layers by progressively fusing the visual embeddings with textual embedding.

In step 412, the method includes calculating a first correlation between the first query and the first key. Referring to system 300 of FIG. 3, first multi-head cross-attention layer 320 is configured to calculate a first correlation between the first query and the first key.

In step 414, the method includes generating a second key and a second value based at least on the first correlation. Referring to system 100 of FIG. 1, NPU 143 is configured to perform a model training process that adopts an attention mechanism to calculate the first correlation and output a weighted sum of image tokens' embedding guided by the textual information.

In step 416, the method includes generating a second query using at least the visual embedding. Depending on the implementations, in addition to textual embedding, visual embedding is also used as the query. For instance, the second query is generated from the visual embedding to query the weighted sum of image tokens' embedding generated at step 414 to enhance the key and value inputs and develop a richer semantic understanding.

In step 418, the method includes calculating a second correlation between the second query and the second key. Similar to the calculation of the first correlation, an attention mechanism may be employed to calculate the second correlation. In some cases, the weighted sum of image tokens' embedding guided by the textual information can be redistributed to each image token's embeddings according to the second correlation to further refine the visual embedding.

In step 420, the method includes generating a third key and a third value based at least on the second correlation. In various implementations, a third query is generated using at least the first query via an addition skipping connection. The method may further include outputting the third query, key, and value as the output of the decoder.

According to an example, the decoder comprises multiple decoder layers (e.g., six layers), where each decoder layer adopts a similar attention mechanism that draws information from the outputs of the previous decoder layer. In an example, the third query, the third key, and the third value may be fed into the next decoding layer as input to generate a fourth query, a fourth key, and a fourth value via a similar process, where a third correlation between the third query and the third key is calculated.

In some embodiments, the method further includes generating a probability value associated with a relevance between the first image and the plurality of text data. For instance, the output of the decoder (e.g., query, key, and value) may be mapped to per-class probabilities via a shared fully-connected layer (e.g., element 255 of FIG. 2). In a specific example, one or more probability values indicating relevance between one or more objects and one or more label classes may be generated.

When performing the image classification tasks during an inference stage, one or more probability values may be used to determine one or more label classes associated with the one or more objects contained in the input image. Embodiments of the present invention provide state-of-the-art performance for various image classification tasks including, without limitation, conventional multi-label classification, zero-shot multi-label classification, single-to-multi-label classification, and/or the like. Implementations of the described techniques may include hardware, a method or process, or computer software on a computer-accessible medium.

While the above is a full description of the specific embodiments, various modifications, alternative constructions and equivalents may be used. Therefore, the above description and illustrations should not be taken as limiting the scope of the present invention which is defined by the appended claims.

1. A method for image classification, comprising:
obtaining a first image and a plurality of text data;
extracting a visual embedding using the first image;
extracting a textual embedding using the plurality of text data;
generating a first query using at least the textual embedding;
generating a first key and a first value using at least the visual embedding;
calculating a first correlation between the first query and the first key;
generating a second key and a second value based at least on the first correlation;
generating a second query using at least the visual embedding;
calculating a second correlation between the second query and the second key; and
generating a third key and a third value based at least on the second correlation.

2. The method of claim 1 further comprising generating a third query using at least the first query.

3. The method of claim 2 further comprising outputting the third query.

4. The method of claim 1 further comprising outputting the third key and the third value.

5. The method of claim 1 wherein the plurality of text data comprises label class information.

6. The method of claim 1 wherein the visual embedding is aligned with the textual embedding via a pre-trained model.

7. The method of claim 6 wherein the pre-trained model is stored in a data storage.

8. The method of claim 1 further comprising generating a probability value associated with a relevance between the first image and the plurality of text data.

9. The method of claim 1 wherein the first image is stored in a memory.

10. A system for image classification, comprising:
a communication interface configured to obtain a first image and a plurality of text data;
a memory coupled to the communication interface, the memory being configured to store the first image and the plurality of text data;
a processor coupled to the memory, the processor being configured for:
extracting a visual embedding using the first image;
extracting a textual embedding using the plurality of text data;
generating a first query using at least the textual embedding;
generating a first key and a first value using at least the visual embedding;
calculating a first correlation between the first query and the first key;
generating a second key and a second value based at least on the first correlation;
generating a second query using at least the visual embedding;
calculating a second correlation between the second query and the second key; and
generating a third key and a third value based at least on the second correlation.

11. The system of claim 10 wherein the processor comprises a graphics processing unit (GPU) and/or a central processing unit (CPU).

12. The system of claim 10 wherein the processor is further configured to generate a third query using at least the first query.

13. The system of claim 12 further comprising a data storage configured to store a pre-trained model, the pre-trained model being configured to align the textual embedding with the visual embedding.

14. The system of claim 12 wherein the processor is further configured to generate a probability value associated with a relevance between the first image and the plurality of text data.

15. A method for image classification, comprising:
obtaining a first image, the first image comprising one or more objects;
obtaining a plurality of text data, the plurality of text data comprising one or more label classes corresponding to the one or more objects;
extracting a visual embedding using the first image;
extracting a textual embedding using the plurality of text data;
generating a first query using at least the textual embedding;
generating a first key and a first value using at least the visual embedding;
calculating a first correlation between the first query and the first key;
generating a second key and a second value based at least on the first correlation;
generating a second query using at least the visual embedding;
calculating a second correlation between the second query and the second key; and
generating a third key and a third value based at least on the second correlation.

16. The method of claim 15 further comprising generating one or more probability values indicating relevance between the one or more objects and the one or more label classes.

17. The method of claim 15 further comprising determining one or more image labels associated with the one or more objects based at least on the one or more probability values.

18. The method of claim 15 further comprising generating a third query using at least the first query.

19. The method of claim 15 further comprising generating a fourth query and a fourth key and a fourth value using at least the third query and the third key and the third value.

20. The method of claim 15 further comprising calculating a third correlation between the third query and the third key.
